(19) United States
(12) Patent Application Publication
(10) Pub. No.: US 2007/0238348 A1
(43) Pub. Date: Oct. 11, 2007

(54) Prevention of high resistance electrical connections

(76) Inventor: Robert Z. Kopelman, Rockville Centre, NY (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/729,600

(22) Filed: Mar. 28, 2007

Related U.S. Application Data
(60) Provisional application No. 60/786,726, filed on Mar. 28, 2006.
(60) Provisional application No. 60/786,725, filed on Apr. 17, 2006.

(51) Int. Cl. H01R 13/58

(52) U.S. Cl. 439/452

(57) ABSTRACT

A terminal assembly for a device configured to indefinitely retain material therein includes a terminal shaft having a terminal head defined on an end thereof and at least one shaft including a handle and a pin member defined at opposed ends thereof. The handle includes a cam surface configured to bias the terminal head upon operation of the handle, thereby causing the pin to bias at least one compression plate within a compression area defined between the handle and the pin. The handle is configured to operate in a first position wherein the at least one compression plate is biased towards the compression area and a second position wherein the at least one compression plate is retracted from the compression area. The assembly further includes a spring component configured to retain the at least one compression plate within the compression area, wherein the material is retained within the compression area.

This application claims priority from Provisional Patent Application Ser. No. 60/786,726 filed on Mar. 28, 2006 entitled “Prevention of High Resistance Electrical Connections,” the entire contents of which are incorporated herein by reference.

This application also claims priority from Provisional Patent Application Ser. No. 60/786,725 filed on Apr. 17, 2006 entitled “Electrical Fire Prevention from over Temperature Conditions,” the entire contents of which are incorporated herein by reference.

### BACKGROUND

1. Technical Field

The present disclosure relates to electrical devices, systems and methods. More particularly, the present disclosure is directed to electrical devices such as, for example, receptacles including termination terminals, for electrical conductors, such as copper wiring.

2. Background of Related Art

The technology of the present disclosure is designed to prevent fires caused by high resistance connections in electrical devices such as receptacles, cord terminations, power strips, circuit breakers, magnetic starters, etc. More specifically, the present disclosure addresses the problem of glowing connections at the termination points, such as termination terminals, for electrical conductors, such as copper wiring and at the male-prong to female-receptacle connections of electrical devices. Safe termination of electrical connections in electrical devices has eluded the electrical device industry since the advent of residential and commercial use of electricity.

Presently, methods typically employed throughout the electrical device industry to detect overheating conditions at the termination points of electrical devices, include temperature sensing devices, thermal imaging devices, lasers, etc. However, these methods are limited to merely addressing the problem of overheating conditions once the condition has already occurred rather than preventing the condition from occurring in the first place. For example, temperature sensing devices may provide an indication of the overheating condition upon detection and subsequently trigger the power to the electrical device.

Common causes of high resistance connections include loosening of the terminations due to extraneous vibrations as well as expansion and contraction of the termination point and/or the screw terminal. A glowing connection is a high resistance connection, which can form at the interface of a copper wire and a screw terminal, for example, a receptacle, resulting in a fire.

### SUMMARY

The present disclosure relates to a system and method for preventing high resistance connections associated with electrical devices such as, for example, receptacles, by securing permanent and safe termination of electrical connections to prevent loose connections indefinitely.

The present disclosure further relates to a termination assembly for an electrical device such as, for example, a receptacle outlet. The termination assembly is configured to indefinitely retain a conductor such as, for example, copper wire therein to prevent high resistance connections caused by loose connections. In this way, the termination assembly of the present disclosure provides a novel means of preventing high resistance connections not appreciated by conventional termination means. Generally, the termination assembly of the present disclosure includes a spring component, a shaft, a handle, a pin member, at least one compression plate, and a terminal shaft including a terminal head defined thereon. Various material including, for example, conductor wire may be placed between two of the one or more compression plates which are subsequently compressed by operation of the handle and/or terminal head in conjunction with the pin member and spring component to indefinitely retain the conductor wire therein.

Additionally, the present disclosure relates to preventing high resistance connections within a receptacle outlet caused by loose connections associated with male-prong to female-receptacle connections involving plug connectors by indefinitely maintaining the integrity of such connections.

### BRIEF DESCRIPTION OF THE DRAWINGS

Various embodiments of the present disclosure are described herein with reference to the drawings wherein:

FIG. 1 is a perspective view of an electrical receptacle in accordance with the present disclosure;

FIG. 2 is a side elevational view of an assembled terminal assembly of the electrical receptacle of FIG. 1;

FIG. 3 is an exploded assembly view of certain parts of the terminal assembly of FIG. 2; and

FIG. 4 is a side elevational view of an assembled terminal assembly according to certain embodiments of the present disclosure.

### DETAILED DESCRIPTION

Particular embodiments of the present disclosure are described hereinbelow with reference to the accompanying drawings. In the following description, well-known functions or constructions are not described in detail to avoid obscuring the present disclosure in unnecessary detail.

The present disclosure relates to a system and method for preventing high resistance connections associated with electrical devices such as, for example, receptacles, by securing permanent and safe termination of electrical connections, e.g., termination connections, male-prong to female-receptacle connections.

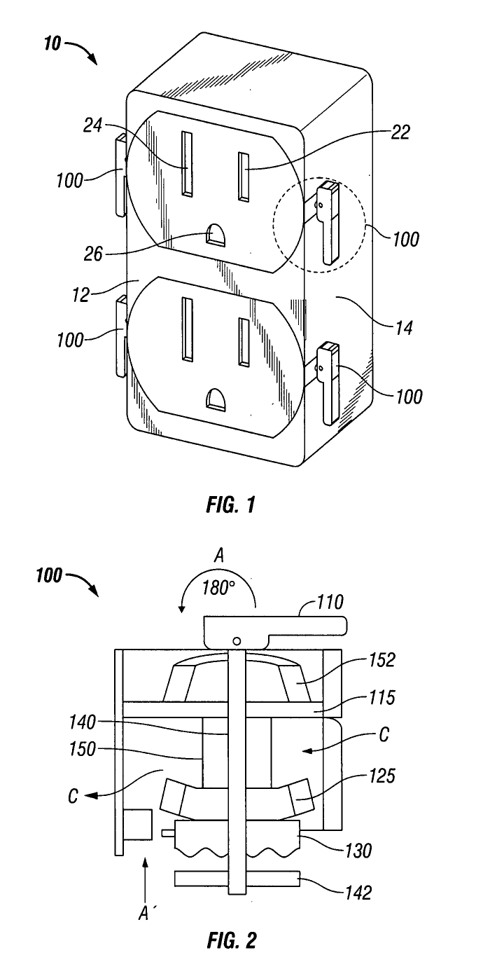

Referring initially to FIG. 1, an electrical device such as a receptacle 10 is shown. The receptacle 10 includes a base cover 12 secured in mated relation to a base 14. Base cover 12 may be secured to base 14 via fasteners (not shown) such as mating via ultrasonic heating, screws, clips, etc. Base cover 12 may be formed of any material which inherently provides high temperature stability such as, for example, thermoplastic plastic. As is conventional, the receptacle 10 may include one or more three-conductor outlets 20 having female line terminal 22, female neutral terminal 24, and a female ground terminals 26. As to be appreciated, ungrounded two prong outlets may also be used and are contemplated by the scope of the present disclosure. Directly electrically connected to the respective female terminals 22, 24 are separate novel terminal assemblies, generally referenced as 100. As shown in FIG. 1, outlet receptacles typically include four termination terminals. For example, line and neutral terminal assemblies may be provided for direct electrical connection to female terminals 22 and 24 respectively, and be configured for connection to a suitable power source, as would be understood by those skilled in the art. It is contemplated that any one of the four terminal assemblies 100 illustrated in FIG. 1 may be employed as line terminal and/or a load going to another device if desired (e.g., powering outlet receptacles in parrallel). It should be understood that the four terminal assemblies 100 depicted in FIG. 1 are illustrative only and in no way limits other possibilities of such number of terminal assemblies as may be needed or desired. Further, the present example in which receptacle 10 is employed to illustrate the use of the novel terminal assemblies is illustrative only and the terminal assemblies are not limited to use with devices which are electrical in nature. For example, the terminal assembly may be used in conjunction with any device in which screw terminals or other terminals configured to secure wire, plugs, prongs, etc. are typically employed. Examples of such devices include, but are not limited to, a laundry line, steel cable, etc.

FIG. 2 shows an assembled view of the terminal assembly 100 identified by phantom lines in FIG. 1. The terminal assemblies are located and held in place between base cover 12 and base 14 by, for example, interior formations molded therein (not shown). Terminal assembly 100 includes a terminal shaft 150 having a terminal head 152 formed at one end. Terminal shaft 150 may be configured to slidably accommodate at least one shaft 140 within a cylindrical throughbore (not shown) formed therethrough, as depicted in FIG. 4. As to be appreciated, FIG. 2 is illustrative only and multiple shafts may be employed with terminal assembly 100 to increase compression if desired, as discussed in further detail below. Alternatively, shaft 140 may be slidably positioned outside and/or along side terminal shaft 150 and configured for operative movement about terminal shaft 150, as depicted in FIG. 2.

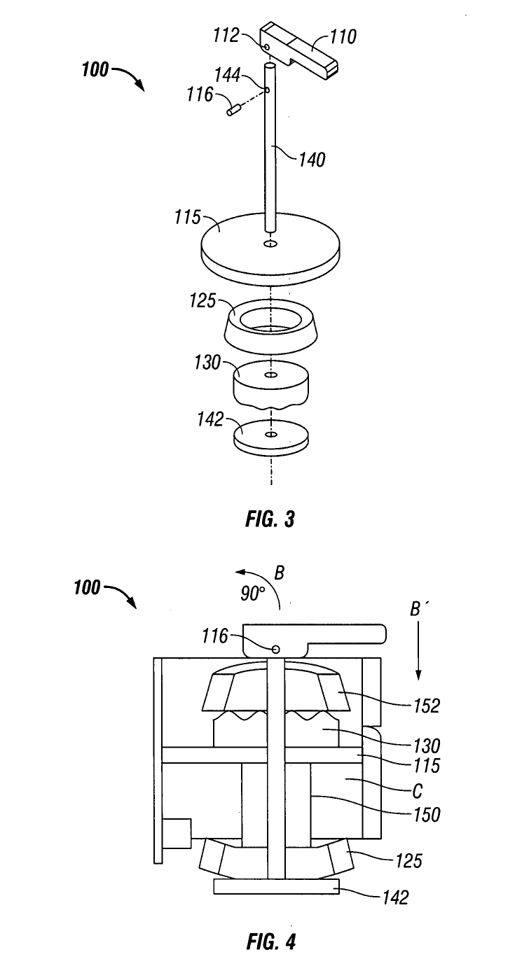

Shaft 140 includes a handle 110 and a pin 142 positioned perpendicular to and at opposed ends of shaft 140. As to be appreciated, shaft 140, handle 110, and pin 142 may be formed of any material of suitable strength sufficient for functional operation of the terminal assembly including, for example, steel, brass, plastic, etc. Pin 142 may be a cylindrical pin, a washer, a fastener such as, for example, a screw, or any type of circular element, as depicted in FIG. 3, suitable for functional operation of the terminal assembly. Shaft 140 may be cylindrical, square, triangular, etc. In accordance with certain embodiments, shaft 140 may be integrally formed with handle 110 and pin 142 as a single unit or alternatively, handle 110 and/or pin 142 may be individual components releasably coupled to shaft 140, as illustrated in FIG. 3. For example, handle 110 may include an annular, cylindrical, triangular, square, or u-shaped recess (not shown) configured to receive one end of shaft 140 therein.

According to certain embodiments, handle 110 may include a throughbore 112 defined therethrough and configured to align with a throughbore 144 formed through a particular end of shaft 140, as illustrated in FIG. 3. With continued reference to FIG. 3, throughbores 112 and 144 may then receive a pivot pin 116 therethrough to secure shaft 140 to handle 110. In this way, pivot pint 116 may serve as a pivot point for handle 110 about shaft 140 as will be discussed in further detail below. Handle 110 further includes a camming surface 114 on one side thereof (FIG. 3) configured to cam the surface of terminal head 152 upon operation of handle 110 as will be discussed in further detail below.

Terminal assembly 100 may further include one or more compression plates. The present example illustrated in FIG. 2 shows two compression plates 115 and 125 in spaced relation to each other. FIG. 2 is illustrative only and any amount of compression plates, including a single compression plate, may be used as is practical. Compression plates 115 and 125 are configured to compress material such as for example, cable, wire and/or wire conductor therebetween. Compression plates 115 and 125 are positioned at opposite ends of shaft 140 in spaced relation to each other to form a compression area C therebetween. Compression area C may be configured to accept a conductor (not shown) such as, for example, copper wire into a mated relationship with terminal shaft 150. As to be appreciated, compression plates 115 and 125 may be integrally formed with shaft 140 and configured to move slidably along terminal shaft 150, and additionally or alternatively, compression plates 115 and 125 may be slidably positioned circumferentially around terminal shaft 150, as would be understood in the art. Compression plates 115 and 125 may be formed of any material suitable for functional operation of the terminal assembly such as, for example, steel, stainless steel, brass, plastic, etc. Compression plates 115 and 125 may be flat (FIG. 4) or angled (FIG. 2) to accommodate various sizes of conductors and/or wires within compression area C. As would be understood in the art, compression plates 115 and 125 may be formed at any angle necessary to create a specific amount of inch-lbs of pressure. Further, compression plates 115 and 125 may be constructed of dimpled metal to assist in electrical continuity, as would be understood in the art. Each and any of the at least one compression plates according to the present disclosure may also include sharp edges (not explicitly depicted) configured to dig into material retained within the compression area such as, for example, copper wire, to assist conductivity as well as provide a stable connection of the material to the termination assembly 100, i.e., by preventing sliding or loosening caused by vibration, handling, etc.

With reference to FIG. 2, handle 110 is pivotal about pivot pin 116 in the direction indicated by a directional arrow A from a first position depicted in FIG. 2 wherein compression plates 115 and 125 are compressed toward each other, to a second position (not shown) wherein compression plates 115 and 125 are retracted in spaced relation to each other. It should be understood that handle 110 may be configured to pivot about a longitudinal axis defined by shaft 140 (not explicitly depicted) in a 360° manner as would be practical. For example, the second position of handle 110 may be configured at 90° (FIG. 4) or 270° wherein handle 110 is parallel to the longitudinal axis defined by shaft 140. The second position of handle 110 may also be, for example, configured at 180° (FIG. 2) wherein handle 110 is perpendicular to the longitudinal axis defined by shaft 140. In the first position of handle 110, camming surface 114 is biased against the surface of terminal head 152, as depicted in FIG. 2, so that pin 142 is urged in the direction indicated by directional arrow A′ to bias a spring component 130 against compression plate 125. Consequently, compression plate 125 is urged in the direction indicated by directional arrow A′ by spring component 130 along terminal shaft 150 to compress and indefinitely retain a conductor (not shown) such as, for example, copper wire between itself and compression plate 115. Conversely, upon pivotal movement of handle 110 about pivot pin 116 to the second position, pin 142 retracts in a direction opposite to the direction indicated by directional arrow A′ to a position spaced from spring component 130 so that compression plate 125 is no longer biased by spring component 130. In this way, compression plates 115 and 125 are in a retracted position with respect to each other and, consequently, the conductor and/or wire (not shown) accommodated within compression area C may be released and/or removed. It should be understood that during compression, compression plate 115 may remain stationary with respect to compression plate 125 or alternatively, may be transient in nature in accordance with certain embodiments of the present disclosure as will be discussed in further detail below.

Handle 110 may further include a locking mechanism (not shown) configured to releasably maintain handle in a specific position, e.g., the first position and second position discussed in detail hereinabove. The locking mechanism may be, for example, a protuberance configured to lockably engage an indent or groove in terminal head 152. Other locking mechanisms are also envisioned such as, for example, a screw through the handle configured to engage a threaded throughbore in terminal head 152 and/or shaft 140, or a c-clip, etc.

Also envisioned are configurations for increasing compression within compression area C as would be necessary for securing and retaining larger size material such as, for example, large wire or steel cable. For example, multiple shafts alongside and/or in parallel with shaft 140 may be employed to uniformly bias the surface of spring component 130 and/or compression plates 125 and 115 with pin 142. In this multiple shaft configuration (not shown), as many shafts as would be practical may be used in conjunction with a single handle and pin, i.e., each of the multiple shafts are mated with the same single handle and/or pin, or each of the multiple shafts may include a handle and a pin unto themselves.

Spring component 130 may be constructed of any material having spring-like and/or tensile-like characteristics with a high elastic modulus such as, for example, spring steel. Spring steels commonly used in the industry include high-carbon spring steels, alloy spring steels, stainless spring steels, copper-base spring alloys, and nickel-base spring alloys. Other materials contemplated include, but are not limited to, spring-capable plastic, spiral/helical spring, or variations thereof. Further, spring component 130 may be shaped in various ways such as, for example, a u-shape, an oval, a crescent moon shape, spiral, helical and the like. As would be understood by those skilled in the art, the novel use of spring steel with the present disclosure provides a connection for termination which will not loosen up over time. Further, limitations of conventional termination connections such as the use of screw terminals requiring the installer to tighten the screw to a specific inch-pounds of torque are overcome by the present disclosure.

Other means of preventing high resistance connections according to the present disclosure includes employing spring-like material with a high elastic modulus such as, for example, spring steel are envisioned for use with electrical devices such as, for example, receptacle 10 of FIG. 1. For example, spring component 130 may be employed for indefinitely retaining prongs from a male plug (not shown) within female receptacles such as, for example, female terminals 22 and 24 and female ground terminal 26 of the three-conductor outlet 20 of FIG. 1. In use, spring component 130 may be U shaped spring steel operatively associated with female terminals 22 and 24 configured to accommodate prongs from a male plug (not shown) therein. Other shapes of spring component 130 are envisioned as would be suitable for functionality with female receptacles. Copper or brass receptacles typically used in conventional outlets are disadvantaged by a finite lifespan due to continuous compression and retraction. The advantage realized by utilizing spring component 130 of the present disclosure is that the integrity of the male-prong to female-receptacle connection is preserved indefinitely, i.e., the copper or brass receptacles will be kept in the position of tension, thereby tightly retaining the prongs from male plugs therein. In this manner, high resistance connections due to loose male-prong to female-receptacle connections are prevented.

It is also contemplated that handle 110 may be configured to rotate about the longitudinal axis (not explicitly depicted) defined by shaft 140 in a clockwise or counterclockwise direction. Such rotation may be achieved through use of various tools such as, for example, a screwdriver, wrench, pliers, or alternatively by hand operation. In this way, handle 110 is capable of being positioned to facilitate the biasing of camming surface 114 against the surface of terminal head 152 to compress compression plate 115 towards compression plates 125 as discussed above.

In certain embodiments of the present disclosure, handle 110 may be absent from terminal assembly 100. In this configuration, terminal head 152 may be rotated about the longitudinal axis defined by shaft 140 (not explicitly depicted) in a clockwise or counterclockwise manner. Terminal head 152 may include grooves to accommodate a tool such as, for example, a screwdriver and the like for Phillips-head or flat-head engagement to facilitate rotation. Other configurations of terminal head 152 are envisioned such as, for example, a hexagonal screw, hexagonal bolt, allen-head bolts, etc. In use, shaft 140 and thus, pin 142, may be configured to operatively rotate in unison with terminal head 152 about the longitudinal axis defined by shaft 140. As shown in FIG. 2, the surface of spring component 130 may include grooves and/or edges inclining toward the direction indicated by directional arrow A′. While pin 142 continues to cam the surface of spring component 130 in the position depicted in FIG. 2 (i.e., at the origin of an inclining edge of the surface of spring component 130), spring component 130 is not urged in the direction indicated by directional arrow A′ and thus, compression plate 125 is not biased in the same direction. During rotation, pin 142 may slidably cam the inclining surface of spring component 130 away from the position depicted in FIG. 2. In this manner, pin 142 is permitted to incline in the direction identified by directional arrow A′ thereby urging spring component 130 in the same direction to bias compression plate 125 towards compression plate 115. In this manner, wire and/or conductor wire may be indefinitely retained within compression area C defined between compression plate 125 and compression plate 115. Alternatively, compression plate 125 may be absent from terminal assembly 100 whereby compression area C is defined between spring component 130 and compression plate 115, i.e., the surface of spring component 130 replaces and/or duplicates the function of compression plate 125. As to be appreciated, the embodiment illustrated in the present example may be configured so that spring component 130 is positioned between terminal head 152 and compression plate 115, as depicted in FIG. 4. In this configuration, the functionality is identical to that discussed above however, pin 142 may be repositioned (not shown) between terminal head 152 and spring component 130 and replaced by either another pin or another suitable replacement such as, for example, a fastener and/or a fastener head, etc.

In other embodiments of the present disclosure depicted in FIG. 4, terminal assembly 100 may employ a substantially similar compression method as the terminal assembly depicted in FIG. 2. The functionality of the embodiment of FIG. 4 is substantially identical to the embodiment of FIG. 2 save for the movement of compression plates 115 and 125 and the positioning of spring component 130. For example, spring component 130 may be positioned between terminal head 152 and plate 115. In this way, operation of handle 110 causes spring component 130 to bias plate 115 in the direction indicated by directional arrow B′ towards plate 125 to compress a wire therebetween as previously discussed with respect to the embodiment of FIG. 2. In this configuration, an additional pin member (not shown) may be included between terminal head 152 and plate 115 including spring component 130 positioned therebetween. Upon operation of handle 110, the additional pin member may urge spring member 130 in the direction indicated by directional arrow B′ to bias the surface of plate 115. In this manner, plate 115 is urged in the direction indicated by directional arrow B′ along terminal shaft 150 to compress and retain a conductor (not shown) such as, for example, copper wire between itself and plate 125. In this configuration, plate 125 may remain stationary with respect to plate 115.

While several embodiments of the disclosure have been shown in the drawings and/or discussed herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A terminal assembly for a device configured to indefinitely retain material therein, the terminal assembly comprising:
a terminal shaft having a terminal head defined on an end thereof,
at least one shaft including a handle and a pin member defined at opposed ends thereof, the handle having a cam surface configured to bias the terminal head upon operation of the handle causing the pin to bias an at least one compression plate within a compression area defined between the handle and the pin, wherein the handle is configured to operate in a first position wherein the at least one compression plate is biased towards the compression area and a second position wherein the at least one compression plate is retracted from the compression area; and
a spring component configured to retain the at least one compression plate within the compression area, wherein the material is retained within the compression area.

2. The assembly as in claim 1, wherein the spring component is constructed of spring steel.

3. The assembly as in claim 1, wherein the pin member is a fastener.

4. The assembly as in claim 1, wherein the terminal shaft includes a longitudinal throughbore therethrough configured to slidably accommodate at least one shaft therein.

5. The assembly as in claim 1, wherein the at least one shaft is positioned along side the terminal shaft.

6. The assembly as in claim 1, wherein the at least one compression plate is constructed of dimpled metal configured to assist in electrical conductivity.

7. The assembly as in claim 1, wherein the at least one compression plate includes a sharp edge configured to engagably retain the material within the compression area.

8. The assembly as in claim 1, wherein the pin member, the handle, and the at least one shaft are integrally formed as a monolithic component.

9. The assembly as in claim 1, wherein the pin member, the handle, and the at least one shaft are separate components operatively associated with each other.

10. The assembly as in claim 1, wherein the at least one compression plate is integrally formed with the at least one shaft.

11. The assembly as in claim 1, wherein the at least one compression plate is circumferentially formed about the terminal shaft.

12. An electrical receptacle comprising:
at least one terminal assembly configured to indefinitely retain a material therein, the terminal assembly comprising:
a terminal shaft having a terminal head defined on an end thereof,
at least one shaft including a handle and a pin member defined at opposed ends thereof, the handle having a cam surface configured to bias the terminal head upon operation of the handle causing the pin to bias an at least one compression plate within a compression area defined between the handle and the pin, wherein the handle is configured to operate in a first position wherein the at least one compression plate is biased towards the compression area and a second position wherein the at least one compression plate is retracted from the compression area;
a spring component configured to retain one ore more compression plates within the compression area, wherein the material is retained within the compression area; and
a face cover in mated relation to a base, the face cover having a plurality of apertures each configured to accommodate insertion of a male prong, wherein the spring component is configured to indefinitely retain the prong within each of the apertures.

13. The assembly as in claim 12, wherein the spring component is constructed of spring steel.

14. The assembly as in claim 12, wherein the at least one shaft is positioned along side the terminal shaft.

15. The assembly as in claim 12, wherein the receptacle includes four terminal assemblies.

16. The assembly as in claim 12, wherein the pin member, the handle, and the shaft are integrally formed as a monolithic component.

17. The assembly as in claim 12, wherein the pin member, the handle, and the shaft are separate components operatively associated with each other.

18. The assembly as in claim 12, wherein the at least one compression plate is integrally formed with the shaft.

19. The assembly as in claim 12, wherein the at least one compression plate is circumferentially formed around the terminal shaft.

20. A terminal assembly for a device configured to indefinitely retain material therein, the terminal assembly comprising:
a terminal shaft having a terminal head defined on an end thereof,
at least one shaft configured for operative movement with the terminal shaft, the at least one shaft having at least one pin member defined on at least one end thereof;
a spring component and at least one compression plate defined between the pin member and the terminal head in spaced relation to each other, wherein the pin member is configured to bias the spring component towards the at least one compression plate to retain the material therebetween upon operation of the terminal head.

21. The assembly as in claim 20, wherein the spring component is constructed of spring steel.

22. The assembly as in claim 20, wherein terminal head is configured for operative rotation.
